(19) United States
(12) Patent Application Publication
(10) Pub. No.: US 2026/0177655 A1
(43) Pub. Date: Jun. 25, 2026

(54) INTEGRATED MULTI-SENSOR FUSION SYSTEM FOR DRONE DETECTION AND THREAT ASSESSMENT IN MARITIME ENVIRONMENTS

(71) Applicant: Abu Dhabi Maritime Academy SOLE PROPRIETORSHIP LLC, Abu Dhabi (AE)

(72) Inventors: Talal BALALAA, Abu Dhabi (AE); Dmitry MIKHAYLOV, Abu Dhabi (AE); Muhammad SAEED, Abu Dhabi (AE); Mohamed ALHOSANI, Abu Dhabi (AE)

(21) Appl. No.: 18/988,311

(22) Filed: Dec. 19, 2024

Related U.S. Application Data
(60) Provisional application No. 63/545,775, filed on Oct. 26, 2023.

(51) Int. Cl. G01S 5/02; G01S 5/10; G06V 10/764; G06V 10/80; G06V 10/82; G06V 20/10; G06V 20/40

(52) U.S. Cl. CPC G01S 5/02585; G01S 5/10; G06V 10/764; G06V 10/803; G06V 10/82; G06V 20/10; G06V 20/41; G01S 2205/07

(57) ABSTRACT

This patent presents an integrated multi-sensor fusion system designed to detect and assess drone threats in maritime environments, with a focus on offshore facilities. The system utilizes various sensors, including TDOA, sound, video, and GIS data, processed by specialized neural networks. These data are fused using a Multifaceted Neural Network (MFNN) for comprehensive threat evaluation. A Drone Risk Level (DRL) algorithm assigns risk levels based on drone characteristics. The system addresses maritime-specific challenges, incorporates data augmentation and transfer learning, and offers a robust solution for safeguarding economic, environmental, and national security interests in offshore regions.

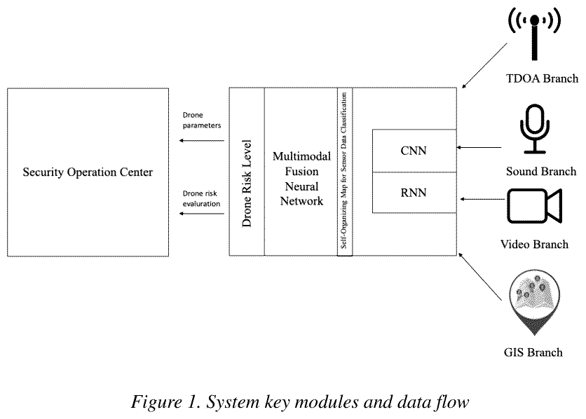

### BACKGROUND

Oil and gas exploration and extraction have been pillars of global energy production. Offshore regions are becoming increasingly vital due to onshore reserves'depletion and other challenges. With the swift advancement of drone technology and its potential malicious uses, notably by terrorists, there's an imperative to develop robust countermeasures. Drones present multifaceted threats, from surveillance to direct attacks.

Importance of securing offshore facilitie:
Economic Significance
   Disruptions can lead to extensive financial losses.
Environmental Implications
   Incidents might result in long-term environmental catastrophes.
Human Safety
   Ensuring the safety of personnel stationed at these platforms is paramount.
National Security Considerations

The changing drone threat landscape brings additional importance to the problem:
Weaponized drones can bypass traditional defenses.
Espionage risks are ever-present.
Drones can mislead security systems, diverting from real threats.

A multi-sensor approach combined with fusion techniques offers enhanced detection:
Single Sensor Limitations: Individual sensors come with inherent challenges.
Strength in Diversity: A broad sensor array creates a comprehensive detection matrix.
Sensor Fusion Techniques: Fusion techniques merge varied sensor data for an accurate threat representation.
Terrain-Specific Challenges: The maritime environment presents unique challenges and necessitates tailored mechanisms.

Artificial intelligence is key to solve emerging threads as multiple data sources are used and fast computation is essential.

### Solution Neural Networks

Following neuro networks are used in proposed invention:
TDOA Integration
   Utilizes multiple sensors to determine the time difference of drone signals'arrival, aiding in accurate drone location determination.
Sound Analysis (Convolutional Neural Network—CNN)
   Sound sensors detect the unique noise signatures of drones. A CNN, known for its excellence in handling spatial hierarchy in data, processes this sound data.
Video Analysis (Recurrent Neural Network—RNN)
   Cameras capture real-time video, and RNNs, particularly Long Short-Term Memory (LSTM) networks, analyze the footage to identify drone type and its movements.
GIS System (Self-Organizing Maps—SOMs)
   A GIS system aided by SOMs maps out potential drone launch points, helping in determining the drone's origin and potential flight path.
Risk Evaluation (Deep Reinforcement Learning—DRL)
   At the heart of the system, DRL evaluates potential risks based on drone behaviors and characteristics, learning over time.
Multimodal Fusion Neural Network (MFNN) for Data Fusion:
   MFNN consists of parallel branches for TDOA, sound, video, and GIS data. Outputs of these branches are fused in higher layers for unified risk assessment.
   Weights are initialized using He initialization. Training is performed using backpropagation with the Adam optimizer. Regularization techniques, like dropout and early stopping, are applied to prevent overfitting.
   Pre-trained models on extensive datasets are utilized as starting points for the sound and video branches, with fine-tuning on drone-specific data.
   Techniques like noise injection for sound and frame skipping for video are employed to artificially expand the dataset.

### Functionality and Training of Each Neural Network

1. Multi-Faceted Neural Network (mfnn) for Data Fusion

The core of this invention lies in the MFNN, which processes data inputs from various sensors, including Time Difference of Arrival (TDOA), sound, and video feeds. The MFNN is trained using supervised learning methods. Training datasets comprise various drone types, movements, and potential payloads. This network is responsible for evaluating potential threats based on drone type, speed, movement, and possible payload.

### Architecture

The MFNN consists of several parallel branches, each designed to process one specific type of data: TDOA, sound, video, and GIS. The outputs of these branches are then fused in higher layers to make a unified prediction or evaluation.
TDOA Branch: This branch takes the time difference of drone signals'arrival as input. It may contain several dense layers to process this data.
Sound Branch (CNN): Given the spatial nature of sound data (frequency vs. time representation), a CNN is employed. Several convolutional layers followed by pooling layers process the sound signature of drones.
Video Branch (RNN): Video data, being sequential, is handled using RNNs, or more specifically, Long Short-Term Memory (LSTM) networks due to their proficiency in handling long sequences without losing information.
GIS Branch: GIS data, which includes spatial coordinates and maybe other metadata, is processed using dense layers.

After processing the data individually, the outputs (feature vectors) of these branches are concatenated and passed through additional dense layers for fusion. This fused information is then used for risk assessment.

### Weight Initialization and Training

Initialization: Weights in the MFNN are initialized using the He initialization method, which is effective for deep networks with ReLU activations.
Training Data: The network is trained using labeled drone data. This includes drone instances with known positions, types, behaviors, and risk levels collected from various oil drilling grounds.
Training Process: Backpropagation with the Adam optimizer is employed for weight updates. Given the complexity and potential class imbalances (some drones may be rarer than others), focal loss can be considered as it gives more importance to hard-to-classify instances.
Regularization: To prevent overfitting, dropout layers are added after the fusion layer and between dense layers. Additionally, early stopping with a patience parameter is employed based on validation loss to prevent overfitting.
Transfer Learning: Given the specialized nature of the task, transfer learning can be employed for the sound and video branches. Pre-trained models on large datasets can be used as a starting point, and fine-tuning is done using the drone-specific data.

### Data Augmentation

Given the challenge of obtaining a vast amount of labeled data in such specialized scenarios, data augmentation techniques are employed:
Sound: Noise injection, pitch shifting, and time stretching.
Video: Frame skipping, rotation, zooming, and brightness adjustment.

### Evaluation Metrics

During and post-training, the MFNN's performance is evaluated using metrics like accuracy, precision, recall, F1 score, and a confusion matrix, especially focusing on the high-risk drone detections.

### 2. Drone Risk Level (DRL) Algorithm

Post MFNN processing, the DRL algorithm evaluates each detected drone's potential threat. The algorithm assigns risk levels based on:
Drone type: Certain drones can carry more significant payloads or can be more agile.
Movement patterns: Erratic or strategic patterns might indicate malicious intent.
Potential payload: Evaluated based on the drone's size and movement dynamics.

### Neural Network and Training

Network Architecture: The DRL model uses a Q-learning algorithm with a deep neural network as a function approximator for the Q-values. This Deep Q-Network (DQN) enables the system to handle vast state spaces and make accurate risk evaluations.
Training:
   i. Experience Replay: To break the correlation between consecutive observations and stabilize training, experiences are stored in a replay memory. Random minibatches from this memory are used to update the network.
   ii. Target Network: To stabilize the learning, a separate network is utilized to calculate the target Q-values. This target network is periodically updated to the main DQN weights.
   iii. Exploration-Exploitation Trade-off: An epsilon-greedy strategy ensures the model explores various drone behaviors while also exploiting known strategies to assess risks.
   iv. Reward Mechanism: The DRL model is trained with rewards—positive for correctly assessing threats and negative for misclassifications. Over time, the system becomes adept at identifying and categorizing drone risks.

### 3. Geographic Information System (GIS) Role in Drone Launch Analysis

GIS System Role and Analysis includes following parameters analysis
i. Remote Sensing Evaluation: Through advanced remote sensing techniques, the system scans small islands, shores, and expansive water areas to determine potential drone launch points.
ii. Island Size Analysis: Utilizes topographical data to determine the size of each island or shore point, categorizing them based on their capacity to serve as drone launch points.
   Example: Larger islands might be flagged as potential locations where larger or multiple drones could be launched.
iii. Distance Analysis: The system calculates how distant each island or shore point is from the oil drilling platform.
   Example: Closer islands might be prioritized for monitoring due to their proximity advantage for drone launches.
iv. Embarkation Risk: It evaluates the accessibility and likelihood of potential terrorists embarking on specific islands based on various factors like their remoteness, accessibility, and known intelligence.
   Example: An isolated island with low boat traffic might be considered a higher risk due to its stealthy nature.
v. Drone Threat Analysis: Differentiates islands based on the type and threat of drones that can be launched from them.
   Example: Islands with suitable infrastructure might be flagged for the potential launch of more advanced or dangerous drones.
vi. Water Area Evaluation: Analyzes different parts of the surrounding waters for their drone launch potential.—Launch Feasibility Analysis: Determines parts of the water where drone launches might be feasible based on factors like water currents, boat traffic, and depth.
   Example: Calmer waters with less boat traffic might be flagged as potential water-based drone launch points.
vii. Patrolling Efficiency: Evaluates which parts of the water are less likely to be drone launch points due to effective patrolling.
   Example: Areas frequently patrolled by security boats would be deemed lower risk for drone launches.

### 4. Self-Organizing Map (SOM) for Sensor Data Classification

Utilizes unsupervised learning to classify sensor data, aiding in the initial stages of data fusion, especially in distinguishing drone signals from ambient noises or other unrelated signals.

A Self-Organizing Map (SOM), tailored for maritime environments, serves as a foundational component to distinguish drone signals from ambient maritime noises and other unrelated signals.

### Architecture & Training

Grid of Nodes: The SOM is composed of a lattice of interconnected nodes, each holding a weight vector congruent to the dimensionality of the input data, which in this case, relates to sensor signals from potential drone activity and other maritime ambient noises.
Training Dynamics: Through iterative competition, cooperation, and adaptation stages, the SOM is trained on a dataset composed of known drone signals juxtaposed against common maritime background noises.
   In the Competition stage, each node assesses its similarity to the input, identifying the “Best Matching Unit” (BMU) for that specific input signal.
   In the Cooperation phase, a neighborhood around the BMU is selected, with its radius generally diminishing as training progresses.
   During Adaptation, weights of the BMU and its neighbors are tweaked to better resemble the training sample, refining the SOM's ability to distinguish drone signatures from other noises.
Noise Filtering: Given the cacophony of sounds in maritime regions, the SOM's primary advantage is its capability to segregate and prioritize signals that match known drone patterns, thereby significantly reducing false positives and enhancing the detection system's accuracy.
Adaptability: As newer drone models and technologies emerge, their unique signal patterns can be introduced into the training set, ensuring that the SOM remains current and adept at detecting the broadest range of potential threats.

1. An integrated multi-sensor fusion system for detecting drones and assessing threats in maritime environments, wherein the system comprises sensors to capture Time Difference of Arrival (TDOA), sound, video, and Geographic Information System (GIS) data.

2. The system of claim 1, wherein the TDOA data is utilized to determine the precise location of detected drones based on differences in signal arrival times across multiple sensors.

3. The system of claim 1, wherein the sound data is processed using a Convolutional Neural Network (CNN) designed to distinguish unique drone noise signatures from ambient maritime noises.

4. The system of claim 1, wherein the video data is processed using a Recurrent Neural Network (RNN) with Long Short-Term Memory (LSTM) capability, enabling the system to analyze sequential footage and identify drone types and movement patterns.

5. The system of claim 1, further comprising a Self-Organizing Map (SOM) that classifies sensor data, distinguishing drone signals from ambient noises or unrelated signals, improving the accuracy of the initial detection phase.

6. The system of claim 1, wherein the GIS data, aided by SOM, maps potential drone launch points, thereby providing insights into a drone's origin and potential flight path.

7. The system of claim 1, further comprising a Multi-Faceted Neural Network (MFNN) that processes and fuses TDOA, sound, video, and GIS data outputs for unified drone threat assessment.

8. The MFNN of claim 7, wherein each type of data is processed through parallel branches designed for specific data types and their outputs are concatenated in higher layers for a fused assessment.

9. The system of claim 1, further comprising a Drone Risk Level (DRL) algorithm, which assigns risk levels based on a drone's type, movement patterns, and potential payload.

10. The DRL of claim 9, using a Q-learning algorithm paired with a deep neural network as a function approximator, thereby enabling the system to handle vast state spaces for accurate risk evaluations.

11. The system of claim 1, wherein the GIS component analyzes remote sensing data, differentiating potential drone launch points based on island characteristics, shore features, and water terrains.

12. The system of claim 1, employing data augmentation techniques such as noise injection for sound and frame skipping for video, facilitating the enhancement of the training dataset.

13. The system of claim 1, leveraging transfer learning, utilizing pre-trained models on large datasets as starting points and fine-tuning with drone-specific data.

14. The system of claim 1, designed to adapt to newer drone models and technologies by introducing their unique signal patterns into the training set, ensuring current and broad-spectrum threat detection.

15. The system of claim 1, wherein the maritime environment-specific challenges are addressed using tailored mechanisms, ensuring the robustness of the system in distinct maritime conditions.

16. The system of claim 1, incorporating a Multimodal Fusion Neural Network (MFNN) for Data Fusion, comprising parallel branches for TDOA, sound, video, and GIS data, and fusing outputs in higher layers for risk assessment.

17. The system of claim 1, wherein weight initialization in the neural networks employs the He initialization method, proving effective for deep networks with ReLU activations.

18. The system of claim 1, wherein evaluation metrics, including accuracy, precision, recall, F1 score, and confusion matrix, are employed to monitor and assess the performance of the neural networks, emphasizing the accuracy of high-risk drone detections.

19. The system of claim 1, designed with an emphasis on addressing the challenges presented by the maritime environment, such as the ambient noise of the ocean, interference from other marine vessels, and the unique characteristics of offshore installations.

20. A method for detecting and assessing drone threats in maritime environments using the integrated multi-sensor fusion system of claim 1, comprising the steps of capturing data, processing through specific neural networks, fusing the outputs, and evaluating potential threats for accurate and timely response.
